(19) United States
(12) Patent Application Publication
(10) Pub. No.: US 2008/0110649 A1
(43) Pub. Date: May 15, 2008

(54) Folding disk with wing stabilizer wheels

(75) Inventors: Richard Joseph Connell, Slater, IA (US); James Franklin Bierl, West Des Moines, IA (US)

Correspondence Address: DEERE & COMPANY, ONE JOHN DEERE PLACE, MOLINE, IL, 61265, US

(73) Assignee: Deere and Company

(21) Appl. No.: 11/588,757

(22) Filed: Oct. 27, 2006

(51) Int. Cl. A01B 63/14

(52) U.S. Cl. 172/317

(57) ABSTRACT

Gauge or stabilizer wheels are located at the outer front portions of disk wing frames and are connected for operation with other disk wheels on the main and wing frames. The front stabilizer wheels bear much of the wing loading and allow the wing primary depth control wheels to be positioned further to the rear of the machine. The front stabilizer wheels can be hydraulically controlled for on-the-go forward depth control adjustments and provide frame support when the disk is in a field transport position.

### FIELD OF THE INVENTION

The present invention relates generally to multi-section agricultural implements and more specifically to folding disks.

### BACKGROUND OF THE INVENTION

Depth control on the front, outer corner of wing-folding disks is difficult to maintain because of the forces acting on the disk blades at the corner. The combination of side thrust forces along the axis of the disk gang and draft forces perpendicular to the axis of the gang results in the outer disk blades trying to go deeper while the blades on the opposite end of the gang react by rising to shallower depths. Reliance on the primary wing lift wheel assemblies is often ineffective since the wheels are located behind the front gang and ground contour changes will have already passed the front gangs before being encountered by the wheels.

Several approaches exist to counter the negative effects of the side and draft forces. One approach is a rigid frame structure to minimize deflection with depth control maintained through the lift wheels. A second approach commonly used in single offset disks requires addition of weight or change in hitch pull point to balance forces across the machine width. A third alternative is use of hydraulic force to control wing frame forces and prevent gouging. A rigid hinge structure may be used to control the outer gang by eliminating deflection.

Stabilizer wheels installed on the outer corners of folding disks also are used to control depth. Commonly, a manual adjustment is used to set depth, and on-the-go depth control is not available. Also, with the wings unfolded the corner wheels fail to provide support for the frame during field transport, and the rear wheels have to support the wing weight during transport. The position of the wing depth control wheels is close to the center of the wing so that heavier, stronger more costly frames are required to limit frame deflection.

The corner depth control problems increase with wing size. As a result, as disks are made larger, there are more limitations on optimum performance than with narrower width disks. The outer wing depth control wheels must be positioned such that the wings are balanced during field transport and front gang depth control function is maintained during disking operations. Disks equipped with manually adjusted gage wheels can be adjusted for improved performance but this adjustment must be maintained with each change of disking depth. This problem is common with three- or four-section disks that have one set of folding wings, as well as five-section disks having two sets of folding wings.

### SUMMARY OF THE INVENTION

Mechanically or hydraulically actuated gauge wheels are located at the outer front portions of the wing frames and are connected for operation with the main frame and primary wing frame depth control wheels. The front stabilizer wheels bear much of the loading of the wings and allow the wing primary depth control wheels to be positioned closer to the rear of the machine than in at least most previously available multi-section folding disks.

In one embodiment of the invention, the front gauge wheels are hydraulically controlled by a control valve on the tractor. Independent control allows the operator to make on-the-go depth control adjustments at the front of the disk depending on field conditions. In another embodiment, the front gauge wheels can be tied mechanically to the primary wing depth control wheels by an adjustable link such as a turnbuckle to decrease system complexity.

During operation, the front stabilizer wheels help control the forces on the outer wing gang to prevent wing gouging problems commonly experienced on most other free-floating disk wings. The adjustable on-the-go stabilizer wheels improve wing performance significantly compared to disks that rely on the wing depth control wheels to prevent gouging. The stabilizer wheels are located adjacent the front gang and can follow ground contour changes before the wing disk blades encounter the changes.

Frame deflection in the outer wing frame members is reduced compared to manually adjusted front stabilizer wheels since both the front stabilizer wheels and rear wheels provide support. With the support of the front stabilizer wheels during field transport, the position of the wing depth control wheels can be positioned near the rear of the frame so that very expensive heavy frames are no longer required. Wing weight is shared by the front gauge wheels and rear wheels during field transport for more balanced wheel loading. Additional rear weight of rear attachments such as a coil tine harrow that shifts weight balance to the rear of the disk is more effectively supported by the new wheel arrangement. The wheel arrangement also permits the disk size to be increased without compromising depth control performance. The gauge wheel concept can also be used with narrower three-section frames to enhance implement performance.

### BRIEF DESCRIPTION OF THE DRAWINGS

FIG. 1 is a perspective view of a multi-section disk with front stabilizer wheels.

FIG. 2 is a schematic of the hydraulic system for the disk of FIG. 1.

### DESCRIPTION OF THE PREFERRED EMBODIMENT

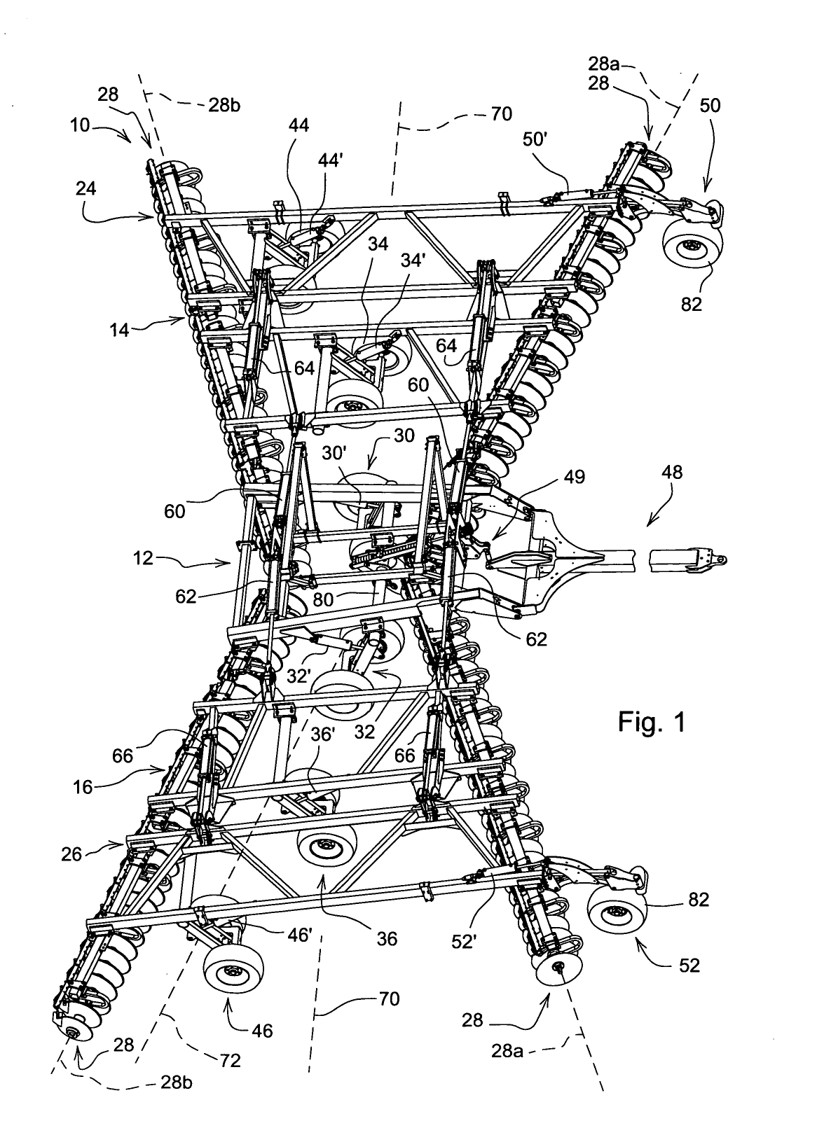

Referring now to FIG. 1, an agricultural implement such as a disk 10 includes a center main frame 12, left and right inner or primary wing frames 14 and 16, and outer wing frames 24 and 26 supporting forward and rearward angled gangs of earthworking tools such as disk blade assemblies 28. The main frame 12 is supported by lift wheel assemblies 30 and 32. The inner wing frames 14 and 16 are hinged from the main frame 12 and include lift wheel assemblies 34 and 36. The outer wing frames 24 and 26 are hinged to the outermost portions of the inner wing frames 14 and 16 and include lift wheel assemblies 44 and 46. A forward leveling hitch 48 connected at an aft end to the center main frame 12 is adapted for connection to a tractor (not shown) for forward movement over the ground. A leveling linkage 49 is connected between the hitch 48 and the lift wheel assemblies 30 and 32 to control disk attitude as the disk 10 is raised and lowered. The hinged frame connections and wheel assemblies enable the implement 10 to flex so the disk blades 28 are better able to the follow the ground contour.

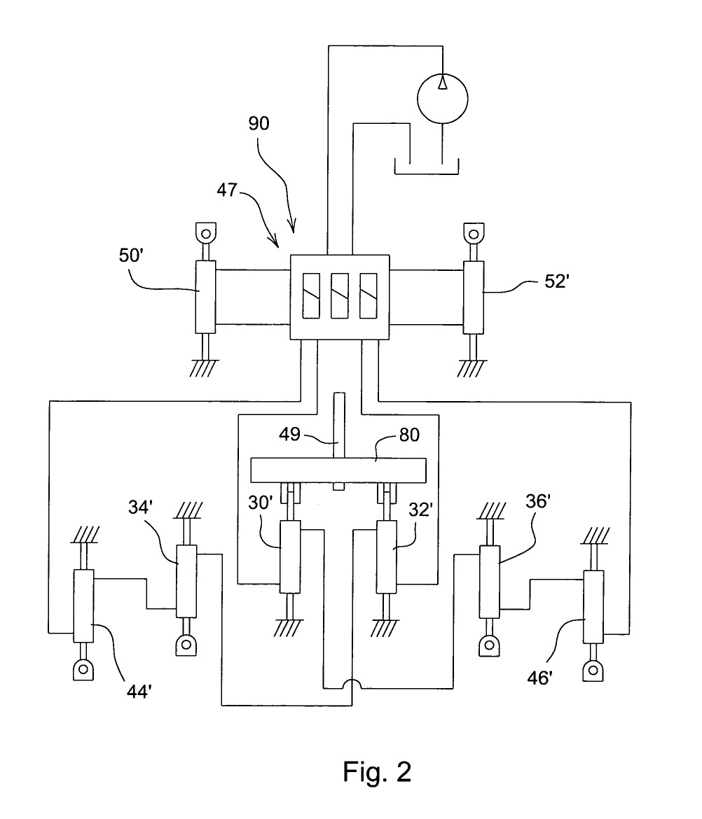

The lift wheel assemblies 30-46 include corresponding hydraulic cylinders 30′-46′ connected to selective control valve structure 47 (FIG. 2) in the tractor cab for raising and lowering the frames between field-working positions and a field transport position (shown) and for adjusting the working depth of the disk 10 when in the field-working position. Vertically adjustable stabilizer wheel assemblies 50 and 52 are connected to the outer front portions of the wing frames 24 and 26 forwardly of the front gangs of disks 28. The stabilizer wheel assemblies 50 and 52 include cylinders 50′ and 52′ connected for lift and depth control operation with the main frame and primary wing frame lift wheel assemblies 30, 32, 34 and 36. Alternatively, the stabilizer wheel assemblies 50 and 52 can be mechanically tied to the corresponding outer wing lift wheel assemblies 44 and 46, respectively. The front stabilizer wheel assemblies 50 and 52 bear much of the loading of the wing frames and allow the primary depth control wheel assemblies to be positioned close to the rear of the disk 10 forwardly adjacent the rear gangs of disks 28.

Wing fold cylinders 60, 62, 64 and 66 unfold and fold the wing frames to and from an extended field-working position (shown). When the disk 10 is narrowed for road transport, the outer wing frames 24 and 26 are folded over the inner wing frames 14 and 16 by retracting the cylinders 64, 66. The inner wing frames 14 and 16 are pivoted upwardly relative to the center frame 12 by retracting the cylinders 60, 62. To position the disk 10 for field transport, the process is reversed and the cylinders are extended. Once the disk 10 is in the field transport position as shown in FIG. 1, the cylinders 30′-46′ of the wheels assemblies 30-46 and the cylinders 50′,52′ of the of the stabilizer wheel assemblies 50 and 52 are retracted to lower the disk blade assemblies into ground contact. The wheel assemblies also provide disk depth control.

As seen in FIG. 1, the forward and rear disk blade assemblies 28 are offset on opposite fore-and-aft sides of a transversely extending disk centerline 70. The disk 10 is generally symmetrical about fore-and-aft center plane. The forward disk blade assemblies 28 of each disk half lie generally on an axis 28a in the field transport position, and the rearward disk blade assemblies 28 lie generally on an axis 28b. The axes 28a and 28b diverge in the outward direction from the centerline 70. The wheel assemblies 32, 36 and 38 lie generally along a wheel location line 72 which is approximately parallel to the rear disk axis 28b. The wheel assembly 46 is located centrally between the centerline 70 and the disk axis 28b and is offset rearwardly from the front disk axis 28a substantially greater than half of the total distance between the front and rear disk assemblies 28. As shown, the rearward offset is approximately two-thirds of the total distance between the front and rear disk assemblies 28. The stabilizer wheel assemblies 50 and 52 include caster wheels 82 having axes of rotation located forwardly of the disk axes 28a.

Locating the wing lift wheel assemblies rearwardly of the centerline 70 and the stabilizer wheel assemblies forwardly of the disk assemblies 28 provides excellent machine support and eliminates need for expensive heavy frames. Wing weight is shared by the front stabilizer wheel assemblies 50 and 52 and the rear lift wheel assemblies 34, 44 and 36, 46 during field transport for more balanced wheel loading. Rear attachments, such as coil tine harrows, that shift weight balance to the rear of the disk is more effectively supported by above-described wheel arrangement. The leveling linkage 49 on the hitch 48 provides additional load sharing and stabilizing for the implement.

As shown in FIG. 2, the right side wing lift cylinders 36′ and 46′ are connected in series with each other and with the left side main frame lift cylinder 30′. The right side main frame cylinder 32′ is connected in series with the wing lift cylinders 34′ and 44′. The main frame lift cylinders 30′ and 32′ are mechanically tied and constrained for operation in unison by a rockshaft 80. The series connection provides level lift operation across the width of the disk 10. In one embodiment, the stabilizer wheel assembly cylinders 50′ and 52′ are connected in series with the corresponding outer wing lift cylinders 44′ and 46′, respectively. In another embodiment, a separate stabilizer wheel controls 90 can be provided at the selective control valve 48 to provide independent control of the cylinders 50′ and 52′.

Having described the preferred embodiment, it will become apparent that various modifications can be made without departing from the scope of the invention as defined in the accompanying claims.

1. A multi-section flexible disk having a center frame and an outer wing frame pivotally connected to the center frame adapted for movement in a forward direction over ground with changing contour, the center frame extending transversely to the forward direction and including transversely spaced main lift wheel assemblies located at opposite sides of the center frame, the outer wing frame pivotal upwardly relative to the center frame, the disk having a transversely extending centerline, a forward disk assembly connected to a forward most portion of the wing frame forwardly of the centerline, a rear disk assembly connected to an aft portion of the wing frame rearwardly of the centerline, a lift and depth control wheel assembly connected to the wing frame adjacent the rear disk assembly rearwardly of the centerline for adjusting depth of penetration of the front and rear disk assemblies and for raising the wing frame to a field transport position, a forward stabilizer wheel assembly including a ground wheel connected to the wing frame forwardly adjacent the forward disk assembly, and a remotely actuatable stabilizer depth control structure including a lift cylinder connected to the forward stabilizer wheel assembly for raising and lowering the ground wheel relative to the wing frame and thereby adjusting the depth of penetration of a forward portion of the wing frame on-the-go independently of operation of the mail lift wheel assemblies; and wherein the stabilizer wheel assembly provides ground support of the wing frame when the wing frame is in the field transport position and is lifted from ground contact when the wing frame is pivoted upwardly relative to the center frame.

2. The disk as set forth in claim 1 wherein the lift and depth control wheel assembly is centrally located between the centerline and the rear disk assembly.

3. The disk as set forth in claim 2 wherein the center frame main lift wheel assemblies include a center frame lift wheel assembly located adjacent the centerline and hydraulically connected to the lift and depth control wheel assembly for selective hydraulic operation of the center frame lift wheel assembly in unison with the lift and depth control wheel assembly.

4. The disk as set forth in claim 1 including an inner wing frame located between the outer wing frame and the center frame, and an inner wing frame wheel assembly offset forwardly from the lift and depth control wheel assembly and rearwardly adjacent the centerline, and wherein the inner wing frame is pivotable upwardly relative to the center frame.

5. The disk as set forth in claim 4 wherein the center frame includes a center frame lift wheel assembly located adjacent the centerline, and wherein the wing wheel frame assembly and the center frame lift wheel assembly are hydraulically connected for operation in unison, the stabilizer depth control operable to extend and retract the lift cylinder on-the-go independently of operation of the wing frame assembly and independently of rockshaft structure extending from the center frame towards to the outer wing frame.

6. The disk as set forth in claim 5 wherein the center lift wheel assembly, the inner wing frame wheel assembly and the lift and depth control wheel assembly are generally located along a line angling rearwardly in the outward direction relative to the centerline, and wherein the center lift wheel assembly is connected in series with the inner wing frame wheel assembly.

7. A multi-section flexible disk adapted for movement in a forward direction comprising a transversely extending central main frame, first and second inner wing frames pivotally connected to outer ends of the main frame for pivoting upwardly about fore-and-aft extending axes, first and second outer wing frames pivotally connected to the first and second inner wings, respectively, the inner and outer wing frames foldable vertically relative to the main frame from an extended field position to narrow the disk for road transport, forward disks connected to forwardmost portions the inner and outer wing frames, rear disks connected to rear portions of the inner and outer wing frames, the forward and rear disks offset on opposite fore-and-aft sides of a transversely extending disk centerline, outer wing lift wheel assemblies connected to the rear portions of the outer wing frames rearwardly of the centerline, and stabilizer wheel assemblies connected forward outermost portions of the wing frame assemblies forwardly of the centerline, the stabilizer wheel assemblies hydraulically operable on-the-go independently of the outer wing lift wheel assemblies for adjustment vertically to provide on-the-go depth control for the forward disks and support of the outer wing frames when wing frames are in the extended field position; and wherein the stabilizer wheel assemblies and the lift wheel assemblies include stabilizer and wheel hydraulic lift cylinders connected hydraulically to a cylinder control circuit for control of the stabilizer hydraulic lift cylinders independently of the wheel hydraulic lift cylinders.

8. (canceled)

9. The disk as set forth in claim 7 wherein the stabilizer wheel assemblies and the lift wheel assemblies are connected through the cylinder control circuit for selecting hydraulic operation of the stabilizer and wheel lift cylinders in unison to raise and lower the outer wing frames, and wherein the disk further comprises a leveling hitch connected for movement with the lift wheel assemblies.

10. (canceled)

11. The disk as set forth in claim 7 including main frame lift wheel structure connected to the main frame adjacent the centerline, inner wing frame lift wheel assemblies connected to the first and second inner wing frames rearwardly of the centerline and rearwardly of the main frame lift wheel structure.

12. The disk as set forth in claim 11 wherein the stabilizer wheel assemblies are located forwardly of the forward disks.

13. The disk as set forth in claim 11 wherein the outer wing lift wheel assemblies are located rearwardly of the inner wing frame lift wheel assemblies.

14. The disk as set forth in claim 7 wherein the forward and rear disks are offset from each other an offset distance, and wherein the outer wing lift wheel assembly is located rearwardly of the forward disks a distance substantially greater than half the offset distance.

15. The disk as set forth in claim 14 wherein the outer wing lift wheel assembly is located rearwardly of the forward disks a distance of approximately two-thirds the offset distance.

16. The disk as set forth in claim 15 further including inner wing lift wheel assemblies located forwardly of the outer wing lift wheel assemblies.

17. The disk as set forth in claim 16 further including main frame lift wheel assemblies located forwardly of the inner frame lift wheel assemblies.

18. The disk as set forth in claim 17 wherein the main frame, inner wing frame and outer wing frame wheel assemblies on one side of the disk lie generally on a wheel line diverging rearwardly from the centerline.

19. The disk as set forth in claim 18 wherein the rear disks define a rear disk axis lying approximately parallel to the wheel line.

20. The disk as set forth in claim 8 wherein the depth control structure includes a stabilizer wheel control for controlling the stabilizer wheels independently of the lift wheel assemblies.
